(19) United States
(12) Patent Application Publication
(10) Pub. No.: US 2005/0226016 A1
(43) Pub. Date: Oct. 13, 2005

(54) Precharge circuit that adjusts current with temperature

(75) Inventors: Boris Khaykin, West Bloomfield, MI (US); Ivana Milosavljevic, Ann Arbor, MI (US)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 10/821,460

(22) Filed: Apr. 9, 2004

(51) Int. Cl. H02M 7/00

(52) U.S. Cl. 363/123

(57) ABSTRACT

An embodiment of the present invention provides for a precharge circuit comprising a power source, a first transistor, a second transistor, and an input node. The power source is in electrical communication with the first transistor where the first transistor selectively conducts current from the power source during a precharge phase. The second transistor is in electrical communication with the first transistor and configured to provide negative feedback to the first transistor. Further, the second transistor is configured to adjust current flowing through the first transistor based on the temperature of the first transistor. The input node is in electrical communication with the first and second transistor and provides an initial signal to activate the precharge circuit.

### BACKGROUND

1. Field of the Invention

The present invention generally relates to a pre-charge circuit that adjusts current flow based on temperature.

2. Description of Related Art

High power modules that utilize large reservoir capacitors are widely used in the automotive industry. In high power modules, such as electric power assist steering (EPAS), large bus capacitors are used to reduce current ripples and provide energy storage. When the module is turned on, the capacitors act as a short circuit and this results in a large current in-rush. The value of the current in-rush will depend on the size of the capacitors, but could be hundreds of amperes. Conventionally, a resistor or thermal resistor is connected in series with the capacitors. The resistor limits the in-rush current to the capacitors, but increases recovery time.

Clearly, it is desirable for the precharge time to be as short as possible. Minimizing precharge time while utilizing a resistor to minimize current in-rush requires a resistor with a high power rating, often a few watts. Resistors with high power ratings, however, are much more expensive than resistors with standard ratings. Further, thermal resistors do not allow a short recovery time due to their thermal time constant.

Alternatively, resistors may be selected with a large enough power rating and resistance value to limit in-rush current in conjunction with a feedback transistor as shown in FIG. 3.72 on page 167 of Horowitz and Hill, “The Art of Electronics”. The drawback of the Horowitz circuit is a long precharge time because current through the MOSFET is limited to be harmless at the highest possible temperature. However, the circuit is designed such that the MOSFET works most of the time at normal and low temperature.

In view of the above, it is apparent that there exists a need for an improved pre-charge circuit that adjusts current with temperature.

### SUMMARY

In satisfying the above need, as well as overcoming the enumerated drawbacks and other limitations of the related art, the present invention provides a precharge circuit comprising a power source, a first transistor, a second transistor, and an input node. The power source is in electrical communication with the first transistor where the first transistor selectively conducts current from the power source during a precharge phase. The second transistor is in electrical communication with the first transistor and configured to provide negative feedback to the first transistor. Further, the second transistor is configured to adjust current flowing through the first transistor based on the temperature of the first transistor. The input node is in electrical communication with the first and second transistor and provides an initial signal to activate the precharge circuit.

In another embodiment of the present invention, the second transistor is configured to decrease the current flowing through the first transistor as the temperature of the first transistor increases. Further, the first transistor is a P-channel MOSFET and the second transistor is a bipolar PNP transistor having a negative base emitter voltage temperature coefficient.

In yet another embodiment of the present invention, the precharge circuit includes a thermal conductor connected between the first and second transistor and configured to transfer heat between the first and second transistor. Further, the circuit trace can be used as a thermal conductor, preferably with a circuit trace width of greater than about 2 mm. The second transistor has to be located as close to the first transistor as possible, preferable not farther than about 5 mm from the first transistor allowing the rise in temperature of the first transistor to raise the temperature of the second transistor thereby adjusting current flow through the first transistor.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a schematic view of a pre-charge circuit that adjusts current with temperature in accordance with the present invention;

FIG. 2 is the layout view of the preferable thermal path; and

FIG. 3 is another embodiment of a pre-charge circuit that adjusts current with temperature in accordance with the present invention.

### DETAILED DESCRIPTION

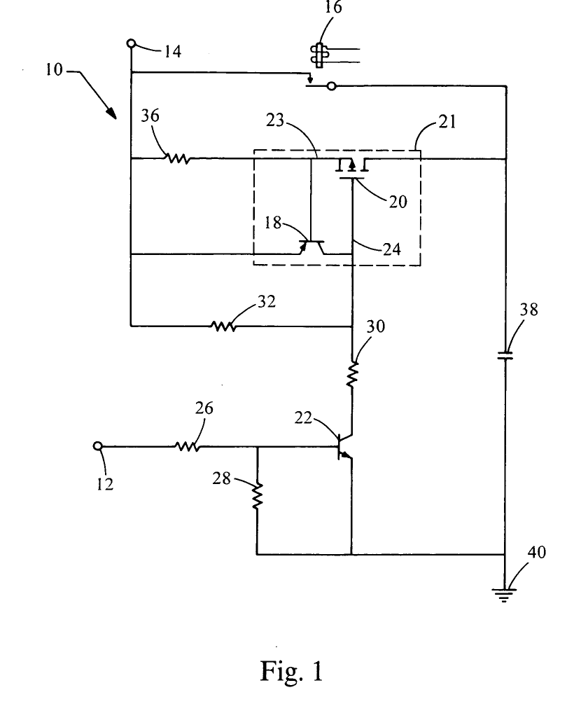

Referring now to FIG. 1, a circuit embodying the principles of the present invention is illustrated therein and designated at 10. The circuit 10 generally includes a power source 14, a first transistor 20, a second transistor 18 and an input node 12.

The circuit 10 receives an input signal at the input node 12, which, in cooperation with other components, causes transistor 20 to conduct. Transistor 18 is configured to provide negative feedback to transistor 20. Further, the circuit 10 is designed such that the location and properties of transistor 18 adjusts the current flowing through transistor 20, inversely proportional to the temperature of transistor 18. This provides a very short precharge time without increasing power dissipation requirements for various components and protects transistor 20 at high temperature.

Now referring to FIG. 1 in detail, an input signal is received at input node 12. Resistor 26 and resistor 28 form a voltage divider between the input node 12 and electrical ground 40. Transistor 22 is connected to the voltage divider such that the input signal causes transistor 22 to conduct. Transistor 22 is shown as an NPN bipolar transistor having its base connected to resistor 26 and resistor 28, its emitter connected to electrical ground and its collector connected to the gate of transistor 20 through resistor 30. As transistor 22 turns on, current begins to flow from the power source 14, through resistor 36 and transistor 20. Although transistor 20 is shown as a P-channel MOSFET, other transistors are contemplated and may be readily used.

When the voltage drop across resistor 36 reaches the base emitter threshold voltage of transistor 18, transistor 18 turns on. Turning on transistor 18 keeps transistor 20 turned on with a constant current flow. As seen in FIG. 1, the base of transistor 18 is connected to the source of transistor 20. The emitter of transistor 18 is connected to power source 14 and its collector is connected to the gate of transistor 20 along circuit trace 24.

Resistor 32 is connected between the gate of transistor 20 on one side, and the emitter of transistor 18 and power source 14 on the other side. The value of resistor 36 can be modified to adjust the initial charging current.

Transistor 18 has a negative base emitter voltage temperature coefficient. Although transistor 18 is shown as a bipolar PNP transistor, other transistors having similar thermal properties may be substituted. One such transistor is commercially available as part number MMBTA56 from Fairchild Semiconductor of South Portland, Me. This particular transistor has a base-emitter voltage equal to 0.72 volts at 27° C. In addition, it has a base emitter voltage of 0.88 volts and 0.52 volts at 40° C. and 125° C. respectively. Therefore, using the specified component, transistor 18 adjusts current in an inversely proportional manner to the temperature of transistor 18, thereby increasing durability of circuit 10.

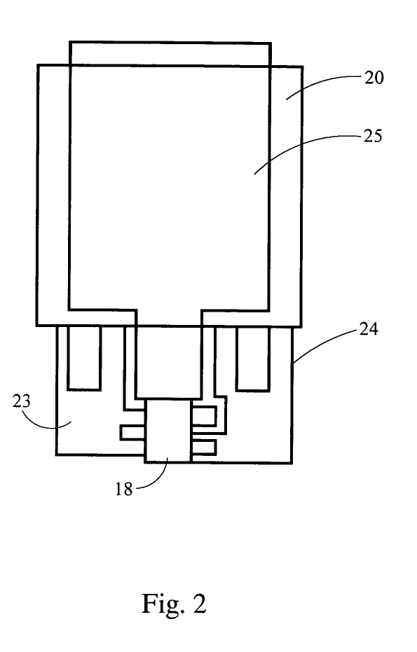

Placing transistor 18 close to transistor 20, the current flow and power dissipation of transistor 20 will decrease as the temperature of transistors 20 and, therefore 18 rises, in effect providing over temperature protection for transistor 20. Preferably, transistor 18 will be located within 5 mm or closer of transistor 20 to thermal path 21 facilitating heat transfer between transistor 18 and transistor 20. In addition, connecting transistor 18 to transistor 20 with a thermal conductor will facilitate the influence of transistor 20 on transistor 18. The circuit traces between transistor 18 and transistor 20 may be used as a thermal conductor such as circuit traces 23 and 24. If the circuit traces are used as a thermal conductor, it is preferred, although not necessary, that the circuit traces are at least 2 mm wide. An example of the Printed Circuit Board layout when the thermal path provided by copper traces for STD10PF06 (transistor 20) and MMBTA56 (transistor 18) is shown in FIG. 2. Other transistors may have different layouts. In addition, a thermal conductor 25 made of metal, preferably copper, or other common conductive materials, may be connected between the packages of transistor 18 and transistor 20 to facilitate heat transfer.

When a predetermined voltage threshold has been exceeded across capacitor 38, relay 16 is energized to connect power source 14 directly to the drain of transistor 20. Therefore, relay 16 bypasses transistor 20 providing a parallel power connection. At low ambient temperatures transistor 20 can dissipate more power than at high temperatures. Transistor 20 can sustain more drain current at lower ambient temperatures before reaching its maximum rated junction temperature.

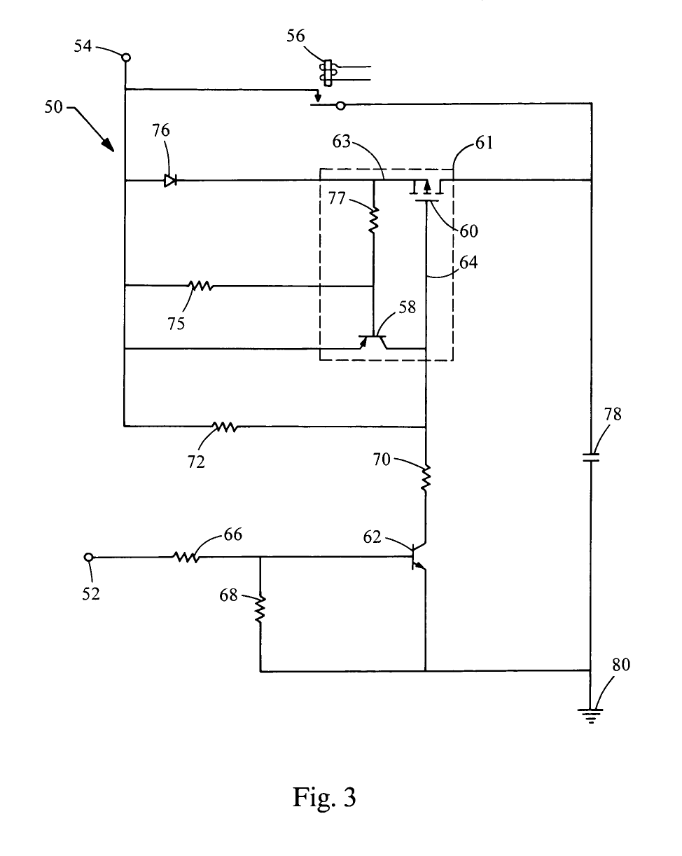

Now referring to FIG. 3, a higher dependence of transistor drain current on temperature can be achieved by replacing resistor 36 in FIG. 1 with diode 76 as shown in circuit 50. Similar to the previous embodiment, an input signal is received at input node 52. Resistor 66 and resistor 68 form a voltage divider between the input node 52 and electrical ground 80. Transistor 62 is connected to the voltage divider such that the input signal causes transistor 62 to conduct. Transistor 62 is shown as an NPN bipolar transistor having its base connected to resistor 66 and resistor 68, its emitter is connected to electrical ground and the collector of transistor 62 is connected to the gate of transistor 60 through resistor 70. As transistor 62 turns on, current begins to flow from power source 54, through diode 76 in the source of transistor 60, and out the drain of transistor 60. Although transistor 60 is shown as a P-channel MOSFET, other transistors may be used.

When the voltage drop across resistor 75 reaches the base-emitter threshold voltage of transistor 58, transistor 58 turns on. Turning on transistor 58 keeps transistor 60 turned on with a constant current flow. Transistor 58 is shown as a bipolar PNP transistor; however, other transistors having similar thermal properties may be substituted. The base of transistor 58 is connected to the source of transistor 60 and the cathode of diode 76 through the voltage divider formed by resistors 77 and 75. Further, the emitter of transistor 58 is connected to power source 54 and the collector of transistor 58 is connected to the gate of transistor 60 along circuit trace 64. Resistor 72 is connected between the gate of transistor 60 on one side, and the emitter of transistor 58 and power source 54 on the other side. The values of resistor 77 and resistor 75 can be modified to adjust the degree of dependence of transistor 60 on transistor 58.

Transistor 58 has a negative base emitter voltage temperature coefficient. Therefore, transistor 58 adjusts current inversely proportional to the temperature of transistor 58, thereby increasing durability of circuit 50. Placing transistor 58 close to transistor 60, the current flow and power dissipation of transistor 60 will decrease as the temperature of transistor 58 rises, in effect providing over temperature protection for transistor 60. Preferably, transistor 58 will be located within 5 mm or closer of transistor 60 to facilitate heat transfer due to the change in transistor 60 temperature. In addition, connecting transistor 58 to transistor 60 with a thermal conductor will facilitate the influence of transistor 60 on transistor 58. The circuit traces between transistor 58 and transistor 60 may be used as a thermal conductor as indicated by circuit trace 63 and 64. If the circuit traces are used as a thermal conductor, it is preferred, although not necessary, that the circuit traces are at least 2 mm wide. Alternatively, a thermal conductor may be connected between the packages of transistor 58 and transistor 60 to facilitate heat transfer.

Circuit 50 allows more drain current through transistor 60 at lower ambient temperatures than higher ambient temperatures. The voltage drop on diode 76 is applied to the base of transistor 58 through the voltage divider formed by resistor 75 and resistor 77. The forward voltage drop on diode 76 and the base-emitter on voltage of transistor 60 have a negative temperature coefficient. However, the temperature coefficient of transistor 58 is greater than the temperature coefficient of diode 76 because the collector current of transistor 58 is much lower than the forward current of diode 76. The voltage drop on sense resistor 36 (FIG. 2) changes with temperature, following base-emitter threshold voltage. The voltage drop on diode 76 has a lower dependence on temperature. Therefore the sensitivity of current limiting in relation to ambient and/or transistor temperature increases, and current will be limited to much lower levels than in the previous embodiment. Other voltage sources can be used instead of the diode 76.

As the transistor 60 or/and ambient temperature increases, the threshold voltage of transistor 58 decreases. Therefore, transistor 58 will turn on at lower current as temperature increases. Transistor 58 will keep transistor 60 in a linear mode close to gate threshold voltage at lower current causing the drain current to decrease. Therefore, for circuit 50 the drain current of transistor 60 decreases as the ambient temperature is elevated.

At low ambient temperatures transistor 60 can dissipate more power than at high temperatures. Accordingly, transistor 60 can sustain more drain current at lower ambient temperatures before reaching its maximum rated junction temperature. When a predetermined voltage threshold has been exceeded across capacitor 78, relay 56 is energized to connect power source 54 to the drain of transistor 60, thereby bypassing transistor 60.

As a person skilled in the art will readily appreciate, the above description is meant as an illustration of implementation of the principles this invention. This description is not intended to limit the scope or application of this invention in that the invention is susceptible to modification, variation and change, without departing from spirit of this invention, as defined in the following claims.

1. A precharge circuit comprising:
a power source;
a first transistor in electrical communication with the power source; and
a second transistor in electrical communication with the first transistor, the second transistor configured to provide feedback to the first transistor and adjust current flowing through the first transistor based on a temperature of the first transistor.

2. The precharge circuit according to claim 1, wherein the second transistor is configured to decrease current flowing through the first transistor as the temperature of the first transistor increases.

3. The precharge circuit according to claim 2, wherein the second transistor is a bipolar transistor.

4. The precharge circuit according to claim 3, wherein the second transistor is a PNP transistor.

5. The precharge circuit according to claim 4, wherein the second transistor has a negative base-emitter voltage temperature coefficient.

6. The precharge circuit according to claim 5, wherein the first transistor is a MOSFET.

7. The precharge circuit according to claim 6, wherein the first transistor is a P-channel MOSFET.

8. The precharge circuit according to claim 3, further comprising a thermal conductor connecting the first and second transistor and configured transfer heat from the first transistor to the second transistor.

9. The precharge circuit according to claim 8, wherein the thermal conductor is a circuit trace.

10. The precharge circuit according to claim 9, wherein the circuit trace has a width of greater than 2 mm.

11. The precharge circuit according to claim 8, wherein the thermal conductor is connected between a body of the first transistor and a body of the second transistor.

12. The precharge circuit according to claim 3, wherein the second transistor is positioned within about 5 mm or closer from the first transistor.

13. The precharge circuit according to claim 3, wherein a collector of the second transistor is connected to a gate of the first transistor.

14. The precharge circuit according to claim 13, further comprising a sense resistor connected between the power source and a source of the first transistor.

15. The precharge circuit according to claim 14, wherein the sense resistor has a power rating of less than 1 Watt.

16. The precharge circuit according to claim 13, further comprising a diode connected between the power source and a source of the first transistor.

17. The precharge circuit according to claim 16, wherein the anode of the diode is connected to the power source and the cathode of the diode is connected to the source of the first transistor.

18. The precharge circuit according to claim 13, wherein a base of the second transistor is connected to the cathode of the diode through a resistor.

19. The precharge circuit according to claim 13, wherein an emitter of the second transistor is in electrical communication with the power source.

20. The precharge circuit according to claim 13, wherein a drain of the first transistor is in electrical communication with an electrical ground through a capacitor.

21. The precharge circuit according to claim 13, further comprising a third transistor in electrical communication with an input node, the first transistor, and the second transistor.

22. The precharge circuit according to claim 21, wherein the third transistor is an NPN transistor.

23. The precharge circuit according to claim 22, wherein a base of the third transistor is connected to the input node through a first resistor.

24. The precharge circuit according to claim 23, wherein a collector of the third transistor is connected to a gate of the first transistor and the collector of the second transistor through a second resistor.

25. The precharge circuit according to claim 24, wherein an emitter of the third transistor is connected to an electrical ground.

26. The precharge circuit according to claim 13, further comprising a relay connected between the power source and a drain of the first transistor.

27. The precharge circuit according to claim 26, wherein the relay is configured to bypass the first transistor when a predetermined voltage threshold has been exceeded at the drain of a first transistor.

28. A precharge circuit comprising:
a power source;
a P-channel MOSFET transistor in electrical communication with the power source;
a bipolar PNP transistor in electrical communication with the P-channel MOSFET transistor, the bipolar PNP transistor configured to provide negative feedback to the P-channel MOSFET transistor and decrease current flowing through the P-channel MOSFET transistor as the temperature of the P-channel MOSFET transistor increases; and
a thermal conductor connected between a collector of the bipolar PNP transistor and a gate of the P-channel MOSFET, the thermal conductor being configured to transfer heat from the P-channel MOSFET to the bipolar PNP transistor.

29. The precharge circuit according to claim 28, wherein the bipolar PNP transistor is positioned within about 5 mm or closer from the first transistor.

30. The precharge circuit according to claim 28, further comprising a resistive load having a power rating of less than 1 Watt, the resistive load being connected between the power source and a source of the P-channel MOSFET.

31. The precharge circuit according to claim 28, further comprising a diode, wherein the anode of the diode is connected to the power source and the cathode of the diode is connected to a source of the P-channel MOSFET.
